(19) United States
(12) Patent Application Publication
(10) Pub. No.: US 2009/0196153 A1
(43) Pub. Date: Aug. 6, 2009

(54) TRACKING ERROR SIGNAL GENERATION METHOD AND OPTICAL DISC APPARATUS

(75) Inventor: Hiroshi Kubota, Fussa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/354,983

(22) Filed: Jan. 16, 2009

(30) Foreign Application Priority Data
Jan. 31, 2008 (JP) 2008-021897

(51) Int. Cl. G11B 7/00

(52) U.S. Cl. 369/112.23

(57) ABSTRACT

According to one embodiment, it is possible to obtain a compensation SPP signal, which compensates a push-pull signal obtained by a ± first-order light or a lens shift compensation signal generated by other method according to phases of a motor to rotate a recording medium, from a MPP signal which is a component indicating the amount of de-tract in a reflected light from any one of recording layers of an optical disc detected by a photodetector, and it is possible to obtain a tracking signal with a high signal-to-noise ratio, by the following equation by using a compensation SPP signal and a MPP signal:

MPP−compensation SPP×k

where k is a constant.

### CROSS-REFERENCE TO RELATED APPLICATIONS

This application is based upon and claims the benefit of priority from Japanese Patent Application No. 2008-021897, filed Jan. 31, 2008, the entire contents of which are incorporated herein by reference.

### BACKGROUND

1. Field

One embodiment of the invention relates to a tracking control method, which increases the accuracy of tracking control in recording information on an optical disc as a recording medium or reproducing recorded information from an optical disc, and provides stable information recording and reproduction, and an optical disc apparatus adopting the same control method.

2. Description of the Related Art

A long time has passed after development of an optical disc apparatus, which records or reproduces information on/from an optical disc by using a laser beam.

As a recording medium (an optical disc), an optical disc of a digital versatile disc (DVD) standard has been widely used. Further, an optical disc of a high definition DVD (a HD DVD) standard has been developed from a DVD disc, and practically used for recording with higher density.

Among DVD and HD DVD discs, in discs other than a play-only ROM type, such as a write once type disc (-R) for recording information only once, and a rewritable type disc (-RAM, -RW) for recording information repeatedly, a recording track (a guide groove, or a flat part opposite to a groove) is formed on an information recording surface of a disc.

When information is recorded on or reproduced from an optical disc, the center of optical spot of a laser beam coincides with the center of a recording track. If the center of optical spot does not trace the center of a recording track, an off-track error occurs, and recording or reproduction of information becomes difficult.

Against this background, by a tracking control, an optical head supporting an objective lens that provides an optical spot of laser beam is moved in the radial direction of an optical disc, to make the center of optical spot coincide with the center of a recording track.

For the tracking control, a photodetector is used to detect a recording track component included in a laser beam reflected on the recording surface of an optical disc.

By processing the output of a photodetector by a method called a push-pull method, it is possible to detect a tracking error, which indicates the degree of displacement between the center of an optical spot and the center of a recording track.

In the push-pull method, a main push-pull (MPP) signal using a zero-order light of a reflected laser beam, and a sub push-pull (SPP) signal using a ± first-order light can be obtained from the output of a photodetector.

For example, Japanese Patent Application Publication (KOKAI) No. 2004-348935 discloses a method of obtaining the amount of deviation from a reference value of MPP by using a main push-pull (MPP) signal and a sub push-pull (SPP) signal, and obtaining a tracking error signal by correcting one of the MPP and SPP signals based on the amount of deviation. This patent document also discloses use of a low-frequency component and DC component of SPP signal.

However, it is obvious that the low-frequency component and DC component of SPP are not completely eliminated even by the technique described in the above patent document, and these components become noise components as a result.

Further, generally, a SPP signal is bad in a signal-to-noise ratio (S/N), and a high-frequency component needs to be eliminated in most cases. Besides, as a SPP signal itself shifts to a DC component, and de-tracks, a DC component must be cancelled in some cases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus according to an embodiment of the invention;

FIG. 2A is a graph showing a relationship between a MPP (main push-pull) signal output from a photodetector in an optical head unit (ACT) of the optical disc apparatus shown in FIG. 1, and an interlayer crosstalk in a recording layer of an optical disc, according to an embodiment of the invention;

FIG. 2B is a graph showing a relationship between a SPP (sub push-pull) signal output from a photodetector in an optical head unit (ACT) of the optical disc apparatus shown in FIG. 1, and an interlayer crosstalk in a recording layer of an optical disc, according to an embodiment of the invention;

FIG. 3A is a graph showing a relationship between a MPP (main push-pull) signal output from a photodetector in an optical head unit (ACT) of the optical disc apparatus shown in FIG. 1, and recording/reproduction to/from a recoding layer of an optical disc, according to an embodiment of the invention;

FIG. 3B is a graph showing a relationship between a SPP (sub push-pull) signal output from a photodetector in an optical head unit (ACT) of the optical disc apparatus shown in FIG. 1, and recording/reproduction to/from a recoding layer of an optical disc, according to an embodiment of the invention;

FIGS. 4A to 4C are graphs showing a relationship between holding (saving) of SPP (sub push-pull) signal output from a photodetector in an optical head unit (ACT) of the optical disc apparatus shown in FIG. 1, and a compensation SPP signal processed from a SPP signal, according to an embodiment of the invention;

FIG. 5 is a flowchart showing holding (saving) of SPP (sub push-pull) shown in FIGS. 4A to 4C, and a method of obtaining a compensation SPP signal processed from a SPP signal, according to an embodiment of the invention; and

FIG. 6 is a flowchart showing the details of holding (saving) SPP (sub push-pull) shown in FIG. 5, and a method of obtaining a compensation SPP signal processed from a SPP signal, according to an embodiment of the invention.

### DETAILED DESCRIPTION

Various embodiments according to the invention will be described hereinafter with reference to the accompanying drawings. In general, according to one embodiment of the invention, an optical disc apparatus comprising: a motor to rotate a recording medium at a predetermined speed; a lens which condenses light from a light source on a recording layer of a recording medium, and captures a reflected light reflected on a recording layer of a recording medium; a support body which supports the lens movably in the optical axis direction of the lens, or in the direction crossing a track or a pit train of a recording medium; a photodetector which detects the reflected light captured by the lens, and outputs a predetermined output signal; a storage unit which extracts displacement generated when the lens moves in the direction crossing a track or a pit train of the recording medium at every rotational phase of the motor, from the output of the photodetector, and holds the result of extraction; and a signal processing unit which obtains a track error signal generated when the lens moves the support body in the direction crossing a track or a pit train of the recording medium, by the equation:

MPP−compensation SPP×k

where MPP indicates a push-pull signal indicating the amount of de-track, compensation SPP is a signal obtained by averaging a SPP signal for each phase of a disc motor, and k is a constant.

Embodiments of this invention will be described in detail with reference to the drawings. The various modules of the systems described herein can be implemented as software applications, hardware and/or software modules, or components on one or more computers, such as servers. While the various modules are illustrated separately, they may share some or all of the same underlying logic or code.

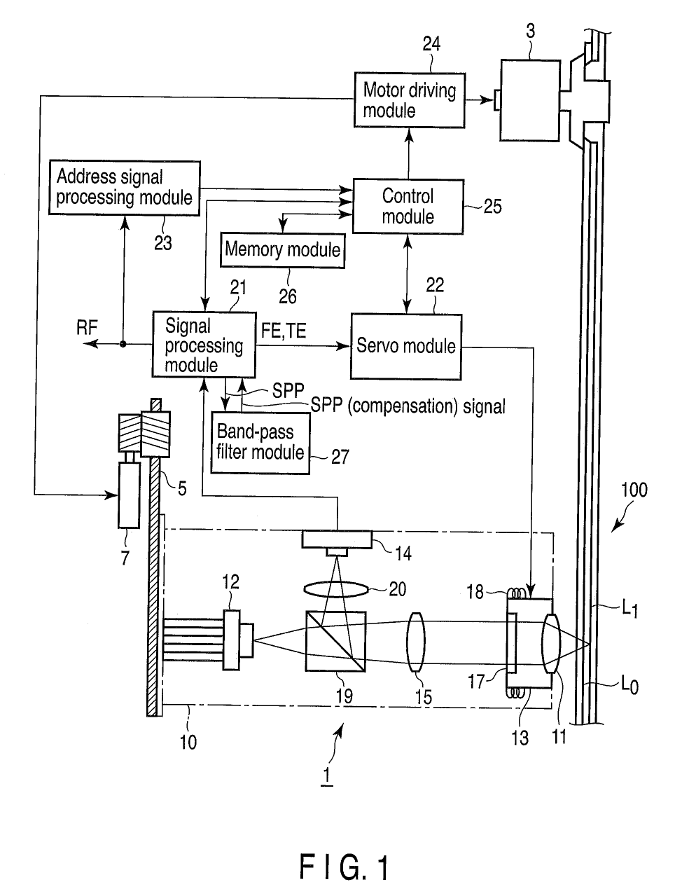

FIG. 1 shows an example of a configuration of an information recording/reproducing apparatus (an optical disc apparatus), to which an embodiment of the invention is adaptable.

An optical disc apparatus 1 shown in FIG. 1 includes an optical pickup unit (an optical head unit) 10, which records information on a recording layer, such as an organic film, a metallic film and a phase-change film not described in detail, formed more than one in a recording medium (an optical disc) 100, or reads recorded information from the recording layer, or erases information recorded on the recording layer. Though not described in detail, the optical disc apparatus 1 includes a disc motor module 3 to rotate the optical disc 100 at a predetermined speed, a head moving mechanism 5 to move the optical head unit 10 along the recording surface of an optical disc D, and mechanical elements, such as a propulsive motor 7 to give a propulsion force to the head moving mechanism 5. The optical disc unit 1, as explained later, includes a signal-processing module 21 to process the output of a photodetector incorporated in the optical head unit 10, and a control module to control the mechanical elements of the optical head unit 10.

The optical head unit 10 is provided close to the optical disc 100, and includes an objective lens 11 which condenses a laser beam from a laser diode (LD) 12 that is a semiconductor laser element, for example, on any one of recording layers L0 and L1 of the optical disc 100, and captures a laser beam reflected on the recording layer. A numerical aperture (NA) of the objective lens 11 is 0.65, for example.

A wavelength of the laser beam output from the laser diode 12 is 400 to 410 nm, preferably 405 nm. The laser diode (LD) 12 may be a combination type capable of outputting a beam with two or more wavelengths. In such a case, a laser diode emits a laser beam with a wavelength of 650 to 680 nm, 770 to 800 nm, 650 to 680 nm, or 770 to 800 nm, in addition to a laser beam of 405 nm.

The objective lens 11 is held by an actuator (hereinafter, called an ACT) 13, and is sequentially moved in the focusing direction and tracking direction, by focus control (focusing) and track control (tracking) explained below.

In the focus control (focusing), the ACT 13 is moved in the thickness direction of a base material of the optical disc 100, and the position of the objective lens 11 is controlled, so that the distance from the lens 11 to the recording layer of the optical disc 100 coincides with a focal point (a focal distance) of the objective lens 11, that is, the distance from the lens to the optical spot where an optical spot generated by being given convergence by the objective lens 11 becomes a minimum. Accompanying with the focus control, the objective lens 11 follows a periodical displacement in the focusing direction occurred at every rotation of the optical disc 100, that is, woobling.

In the track control (tracking), the position of the objective lens 11 is controlled by moving the ACT 13, so that the center of an optical spot (a minimum optical spot) that is given convergence by the objective lens 11 coincides with substantially the center of a track (a guide groove) or a pit train previously formed on an optical disc. If the ACT 13 is inclined, the objective lens 11 can be moved within a range of adjacent several tracks that is smaller than the movement in the direction of track by the head moving mechanism 5 (a lens shift).

A laser beam from the laser diode 12 is passed through a polarization beam splitter (PBS) 19 provided at a predetermined position, collimated (to a parallel light) by a collimator lens (CL) 15, and guided to the objective lens (OL) 11 through a diffraction element 17 in which a light splitting element, or a hologram plate (a hologram optical element (HEO)) is formed in one body with a λ/4 plate (¼ wavelength plate, or a polarization control element). The objective lens 11 and diffraction element 17 are held as one body by the ACT 13.

The laser beam guided to the objective lens 11 is given a predetermined convergence by the objective lens 11, and condensed on one of recording layers L0 and L1 of the optical disc 100. Each of the recording layers L0 and L1 of the optical disc 100 has a guide groove, or a recording track, or a record mark (recorded data) train formed as a concentric circle or a spiral with a pitch of 0.34 to 1.6 μm.

The laser beam given a predetermined convergence by the objective lens 11 is transmitted through a cover layer, not described in detail, of the optical disc, and condensed on any one of recording layers or at a location close to a recording layer (the laser beam from the laser disc 12 forms a minimum optical spot at the focal position of the objective lens 11).

The objective lens 11 is placed at a predetermined position in the direction of track crossing a track (a pit train) in each recording layer of the optical disc 100, and at a predetermined position in the direction of focus that is the thickness direction of a recording layer, as a result of the above-mentioned tracking (track control) and focusing (focus control) by the propulsive force given by an objective lens driving mechanism 18 including a driving coil and a magnet, for example.

The reflected laser beam reflected on any one of the recording layers L0 and L1 of the optical disc 100 is captured by the objective lens 11, converted to a substantially parallel sectional beam shape, and returned to the diffraction element 17.

The diffraction element 17 functions as a λ/4 plate. Therefore, as the polarizing direction of the reflected laser beam is rotated by 90 degrees from the polarizing direction of the laser beam directed to the recording layer of the optical disc 100, the reflected laser beam transmitted through the diffraction element 17 and returned to the polarization beam splitter 19 is reflected on the polarization plane not described in detail of the polarization beam splitter 19.

The reflected laser beam reflected by the polarization beam splitter 19 is given astigmatic aberration by a cylindrical lens 20 having a power inclined by 45 degrees against the tangential or radial direction, and is then given a predetermined convergence by a collimator lens 15, and imaged on the light-receiving plane of a photodetector (PD) 14. At this time, when passing through the diffraction element 17, the reflected laser beam is diffracted to a predetermined number of splits and shape to fit to the arrangement and shape of a detection area (a light-receiving area) previously formed on the light-receiving plane of the photodetector 14.

The current output from the light-receiving part of the photodetector 14 is converted into voltage by a not-shown I/V amplifier (a current-voltage converter), and is applied to a signal-processing module 21, in which the input voltage signal is processed to be used as a periodic signal for linking a lens shift given to the objective lens 11 to reduce the influence of eccentricity caused by a HF (reproduction) output, a track error signal TE, a focus error signal FE, and a chucking between the optical disc 100 and disc motor module 3, with one period of the optical disc 100. Though not described in detail, the HF (reproduction) output is converted to a predetermined signal form, or it is sent to a temporary storage or an external storage through a predetermined interface.

For example, header information (a physical address reproduction signal) among the information recorded on the optical disc 100 that is read by reproducing the HF (reproduction) output is applied to an address signal-processing module 23, in which address information, or the information indicating a track or sector of the optical disc 100 opposing now the objective lens 11 of the optical head unit 100 is taken out, and is supplied to a motor driving module 24.

This determines the speed to rotate the optical disc 100, or the number of driving pulses to be supplied to the disc motor module 3 and the shift amount of the head moving mechanism 5.

The signal-processing module 21, servo module 22, address signal-processing module 23, and motor driving module 24 are controlled by a control module 25. The control module 25 is, as explained later, connected to a memory module 26 to store a rotation signal related to the characteristic (eccentricity) at every period of the optical disc 100.

The signal obtained by the signal-processing module 21 is also used as a servo signal for moving the objective lens 11 of the optical head unit 10 in the direction orthogonal to the plane including the recording surface of the optical disc 100 (the optical axis direction), and in the direction orthogonal to the direction in which a track or a pit train previously formed on the recording surface of an optical disc is extended, through the servo module 22, so that the distance from the objective lens 11 to any one of the recording layers L0 and L1 on the recording surface of the optical disc 100 coincides with the focal distance of the objective lens 11.

A servo signal is generated based on a focus error signal indicating a change in the position of the objective lens 11, so that an optical spot having a predetermined size at the focal position of the objective lens 11 is given the that predetermined size on one of the recording layers L0 and L1 of the optical disc 100, according to a known focus error detection method, and based on a tracking error signal indicating a change in the position of the objective lens 11, so that the optical spot is guided to substantially the center of a line of record marks or a track, according to a known track error detection method.

Namely, the objective lens 11 is moved in a predetermined direction by a servo signal supplied from the servo module 22 to a servo mechanism 18 provided in the ACT 13, so that a beam (a light) spot condensed by the objective lens 11 can be provided at substantially the center of a track formed in each of the recording layers L0 and L1 of the optical disc, i.e., a pit train that is previously recorded information, as a minimum optical spot on the recording layer at that focal distance with each of the recording layers.

A push-pull signal used for the track control (tracking) is available in a MPP (main push-pull) signal using a zero-order of a reflected laser beam, and a SPP (sub push-pull) signal using a first-order light, or a lens shift compensation signal generated in other methods. A SPP signal is usually used to compensate a DC shift component included in a MPP signal.

Therefore, a track error (TE) signal used in the above-mentioned track control (tracking) is obtained by the following equation

TE=MPP−SPP×k

where MPP indicates a push-pull signal indicating the amount of de-track, SPP indicates a push-pull signal using a ± first-order light, or a lens shift compensation signal generated by other methods, and k is a constant.

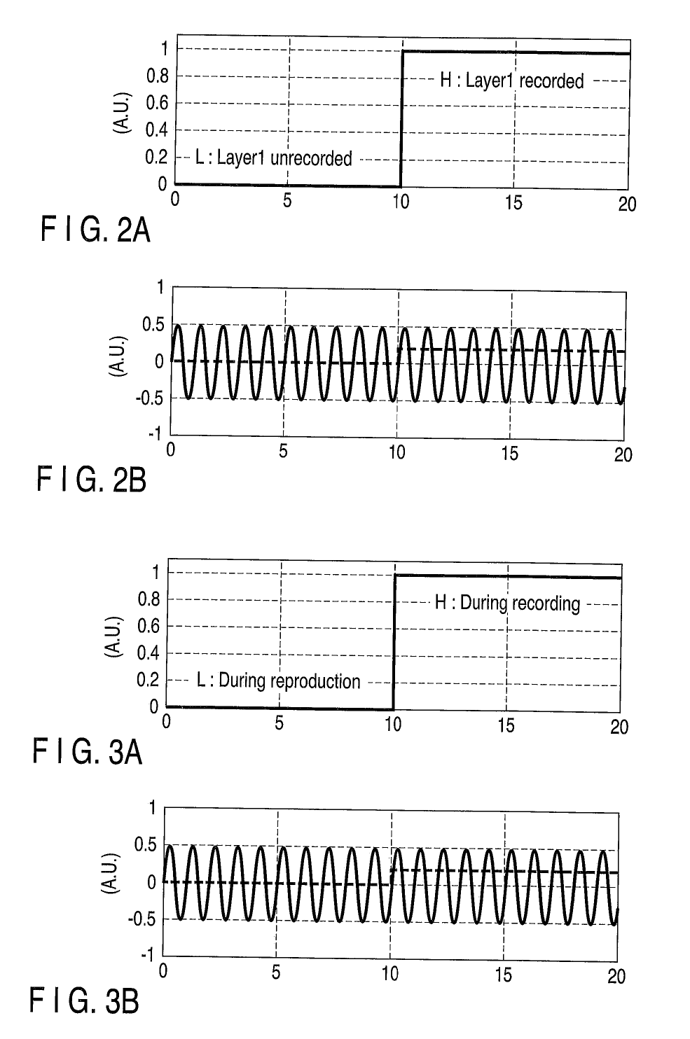

However, it is known that a SPP signal varies depending on a crosstalk between the recording layers L0 and L1 of the optical disc 100 (FIGS. 2A and 2B), and whether a current signal is a recording signal or a reproduction signal (FIGS. 3A and 3B), as shown in FIGS. 2A and 2B and FIGS. 3A and 3B. For example, as shown in FIG. 2A, when the layer L1 is changed from an unrecorded area to a recorded area during reproduction of the layer L0, an offset is generated in a SPP signal as indicated by a dotted line in FIG. 2B (the MPP signal indicated by a solid line is unchanged).

Further, when the signal processing to the layer L0 is changed from reproduction to recording, an offset is generated in a SPP signal as indicated by a dotted line in FIG. 3B (the MPP signal indicated by a solid line is unchanged). As a cause of the offset in the SPP signal, similar to the change from reproduction to recording shown in FIG. 3A, it is also necessary to consider a change in the output of the laser diode (LD) 12 due to continuous recording, and a change in the temperature within the apparatus.

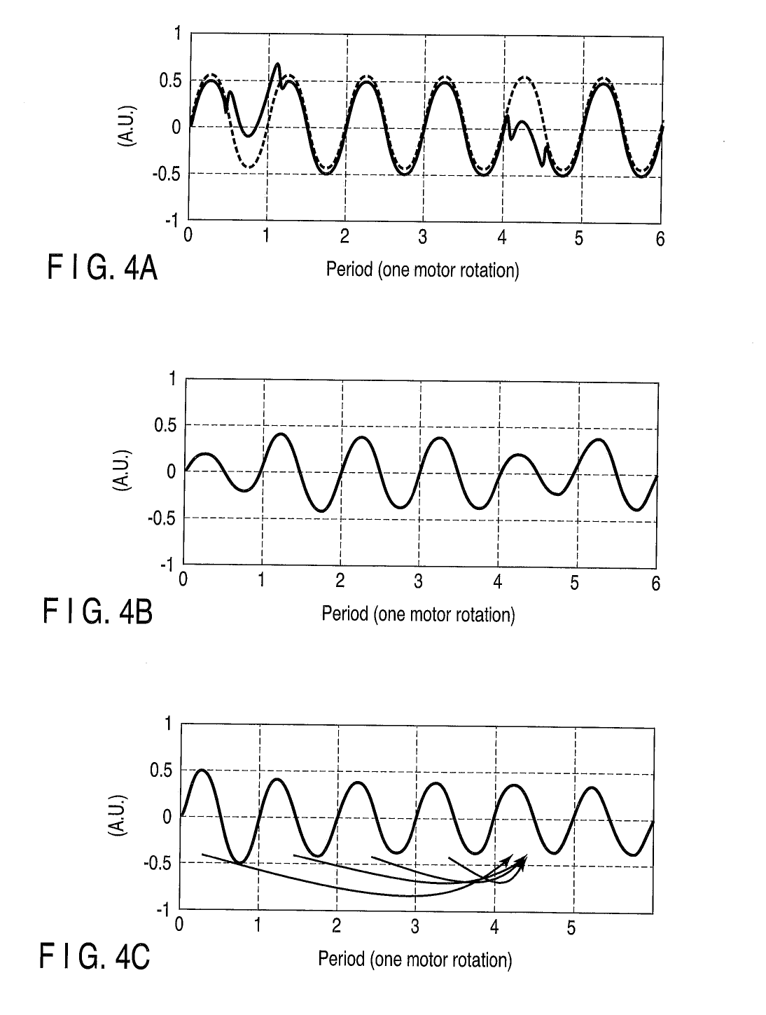

Under the circumstances, as explained hereinafter by suing FIGS. 4A to 4C, it is considered that a compensation SPP signal extracting a rotational frequency component at every rotation period of the disc module 3 is held for a predetermined period (rotations) in a memory (a ring buffer) 26, and when the waveform of compensation SPP signal is disturbed by a noise, the compensation SPP signal for two or more periods held in the memory module 26 is used for compensation.

Namely, as shown in FIG. 4A, for all signal waveforms including a SPP signal waveform not coinciding with an ideal SPP signal indicated by a dotted line, a compensation SPP signal after extracting a rotational frequency component shown in FIG. 4B is obtained, and as shown in FIG. 4C, by using a compensation SPP signal averaged by using a preceding (past) compensation SPP signal for two or more periods (rotations), the influence of offset in a SPP signal as shown in FIGS. 2A and 2B or FIGS. 3A and 3B can be eliminated.

Namely, in this application, a track error (TE) signal used for the track control (tracking) is obtained by the following equation:

TE=MPP−compensation SPP×k

where MPP indicates a push-pull signal indicating the amount of de-track, compensation SPP indicates a signal obtained by averaging a SPP signal for each phase of a disc motor, and k is a constant.

When a compensation SPP signal in that section is to be excluded from the averaging process shown in FIG. 4C, an offset is generated in a SPP signal shown in FIG. 4B with the interlayer crosstalk shown in FIGS. 2A and 2B, and/or interposed when the current signal-processing includes the shift from recording (writing) to reproduction (reading) and vice versa shown in FIG. 3A and 3B.

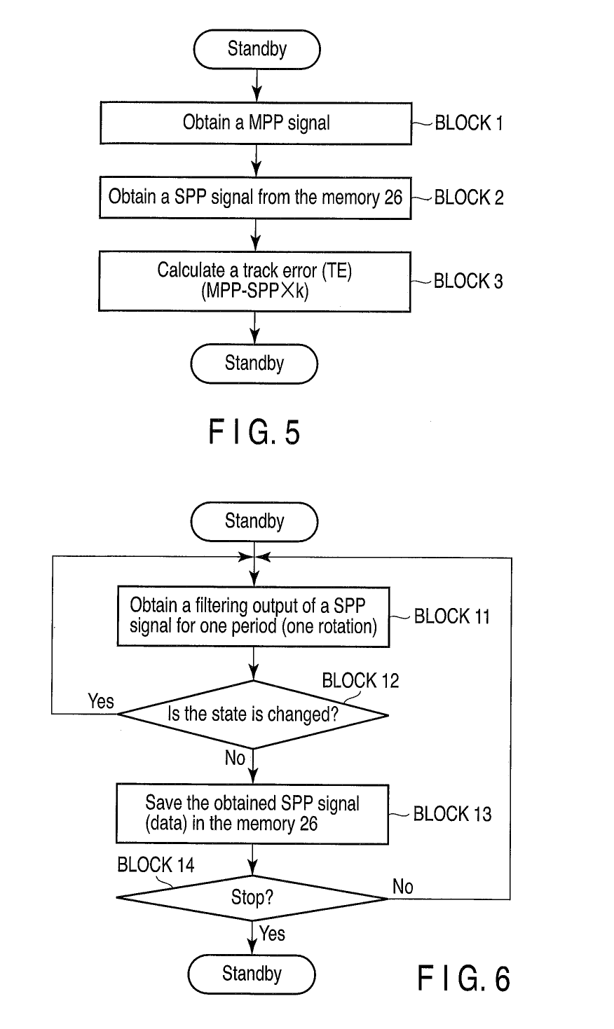

FIGS. 5 and 6 show an example of a procedure of compensating a MPP signal by a compensation SPP signal in the track control (tracking), when obtaining a track error signal.

As shown in FIG. 5, the ACT 13 is moved to a predetermined position, and a MPP signal is obtained from the output of the photodetector 14 by the signal-processing module 21, as ordinary operations (BLOCK 1).

Next, the compensation SPP signal stored in the memory module 26 is taken out (BLOCK 2), and a tracking error signal is obtained by the following equation (BLOCK 3)

TE=MPP−compensation SPP×k

where k is a constant.

A compensation SPP signal is not a SPP signal itself in a signal to correct the amount of DC shift generated for a lens shift included in a MPP signal, but a signal obtained by extracting only a rotational frequency component from a signal that is one or more periods before rotation of a spindle motor. The signal is saved and processed at every rotation of a spindle motor.

FIG. 6 shows a routine procedure for holding the compensation SPP signal shown in FIG. 5, in the memory module 26.

At first, a compensation SPP signal for one rotation period of the disc motor module 3 (one turn of the optical disc 100) is extracted through a band-pass filter (BPF) module 27. The band-pass filter module 27 may be provided as an attachment to the signal-processing module 21, or as an independent device (BLOCK 11).

Then, at least one of a change in the state during the detected one period (one rotation), that is, whether or not a recorded part and an unrecorded part are included in a crosstalk between the recording layers L0 and L1, or whether or not the current signal is shifted from recording (writing) to reproduction (reading) and vice versa is checked (BLOCK 12).

When the state is not changed during one period (one rotation) in BLOCK 12, the SPP signal extracted through the band-pass filter module 27 is stored in the memory module 26. The memory module 26 is a ring buffer, for example, and sequentially stores a predetermined number of SPP signals when the state is not changed. For example, if there are five channels, five SPP signals are sequentially recorded, and a 6^{th} SPP signal is overwritten on the 1^{st} SPP signal (BLOCK 13).

In FIG. 6, the compensation SPP signal held in the memory module in BLOCK 13 is held in units of 1 (one), 5 (five) or 10 (ten) degrees for each channel in the memory module 26.

Namely, the SPP signal input is affected by a interlayer crosstalk and noise, and does not becomes an ideal signal as indicated by a dotted line in FIG. 4A, but becomes a signal as indicated by a solid line.

Therefore, as shown in FIG. 4B, by filtering a SPP signal (by passing through the band-pass filter module 27), a compensation SPP signal is obtained by extracting only a rotational frequency component at every rotation of the disc motor module 3, and is saved in the memory module 26.

As a cutoff frequency of the band-pass filter module 27, in a lower frequency side, if at least a direct current (DC) component can be eliminated, the frequency is set to any frequency lower than a rotational frequency determined by a slowest rotation of the disc motor module 3, in a range of rotation speed in which the disc motor module 3 is rotated for recording or reproduction. In a higher frequency side, the frequency is set to any frequency if it is higher than a maximum rotational frequency when the optical disc 100 is rotated, and is defined as any frequency in a range not deteriorating a rotational frequency component signal. Further, as the rotational frequency of the disc module 3 is varied by a double or 4-time speed control (recoding/reproduction), it is preferable that a cutoff frequency is prepared in more than one in the memory module 26, or as a firmware of the control module 25, and is updated (set) any time according to the rotation of the disc motor module 3 at each time.

Next, as shown in FIG. 4C, a signal actually subtracted from a MPP signal is not an input SPP signal, but an average value of N number of rotations of a compensation SPP signal.

In a signal used as a compensation SPP signal, a period including a state change, from recording (writing) to reproduction (reading) and vice versa, is to be excluded.

Further, a compensation SPP signal is used to cancel a lens shift in the objective lens 11, and only a rotational frequency component of the disc motor module 3 may be extracted for the following reason.

Namely, in a lens shift in a stationary state in which a servo is operated, a rotational frequency component of the disc motor module 3 is dominated by chucking between an optical disc and a turntable of the disc motor module 3, is prevalent.

Further, when a slip between an optical disc and a turntable is substantially zero, a necessary component is determined by the phase of a disc motor, or a rotational angle in one rotation (period), and is the same value in each phase (at every rotation (period)) of a disc motor. Therefore, there is no problem even if data on the last-time rotation of a disc motor is used.

As described above, when a tracking error signal is obtained, by using a compensation SPP signal that is compensated based on a rotation period (phase) of a disk motor (an optical disc), for a SPP signal that is used in combination with a MPP signal, a DC component included in a SPP signal is eliminated, and a signal-to-noise ration is improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a motor to rotate a recording medium at a predetermined speed;
a lens which condenses light from a light source on a recording layer of a recording medium, and captures a reflected light reflected on a recording layer of a recording medium;
a support body which supports the lens movably in the optical axis direction of the lens, or in the direction crossing a track or a pit train of a recording medium;
a photodetector which detects the reflected light captured by the lens, and outputs a predetermined output signal;
a storage unit which extracts displacement generated when the lens moves in the direction crossing a track or a pit train of the recording medium at every rotational phase of the motor, from the output of the photodetector, and holds the result of extraction; and
a signal processing unit which obtains a track error signal generated when the lens moves the support body in the direction crossing a track or a pit train of the recording medium, by the equation:
MPP−compensation SPP×k
where MPP indicates a push-pull signal indicating the amount of de-track, compensation SPP is a signal obtained by averaging a SPP signal for each phase of a disc motor, and k is a constant.

2. The apparatus of claim 1, wherein a rotational phase of the motor is one rotation or one period of the motor.

3. The apparatus of claim 1, wherein among the signals averaged for each phase of the motor, a rotational signal or a periodical signal including a change in state from recording to reproduction and vice versa, is deleted.

4. The apparatus of claim 2, wherein among the signals averaged for each phase of the motor, a rotational signal a periodical signal including a change in an interlayer crosstalk in a recording medium, is deleted.

5. An tracking error signal generation method comprising:
obtaining a compensation SPP signal, which compensates a push-pull signal obtained by a ± first-order light or a lens shift compensation signal generated by other methods according to phases of a motor to rotate a recording medium, from a MPP signal which is a component indicating the amount of de-tract in a reflected light from a recording medium detected by a photodetector; and
obtaining a tracking signal, by the following equation by using a compensation SPP signal and a MPP signal:
MPP−compensation SPP×k
where k is a constant.

6. The method of claim 5, wherein the compensation SPP signal is obtained by averaging a SPP signal that is one or more periods before rotation of the motor, at every rotation or at every period.

7. The method of claim 6, wherein when obtaining a compensation SPP signal by averaging the SPP signal that is one or more periods before rotation of the motor, a rotational signal or a periodical signal including a change in state from recording to reproduction and vice versa, is deleted.

8. The method of claim 6, wherein when obtaining a compensation SPP signal by averaging the SPP signal that is one or more periods before the rotation of the motor, a rotational signal or a periodical signal including a change in an interlayer crosstalk in a recording medium, is deleted.

9. An optical disc apparatus comprising:
a motor to rotate a recording medium at a predetermined speed;
a lens which condenses light from a light source on a recording layer of a recording medium, and captures a reflected light reflected on a recording layer of a recording medium;
a support body which supports the lens movably in the optical axis direction of the lens or in the direction crossing a track or a pit train of a recording medium;
a photodetector which detects the reflected light captured by the lens, and outputs a predetermined output signal;
a storage unit which extracts displacement generated when the lens moves in the direction crossing a track or a pit train of the recording medium at every rotational phase of the motor, from the output of the photodetector, and holds the result of extraction; and
a signal processing unit which obtains a track error signal generated when the lens moves the support body in the direction crossing a track or a pit train of the recording medium, by the equation:
MPP−compensation SPP×k
where MPP indicates a push-pull signal indicating the amount of de-track, compensation SPP is a signal obtained by averaging a SPP signal at every rotation period of a disc motor, and k is a constant.
